(19) United States
(12) Patent Application Publication
(10) Pub. No.: US 2026/0351241 A1
(43) Pub. Date: Nov. 5, 2026

(54) VOICE INTERACTION METHOD AND DEVICE

(71) Applicant: Lenovo (Beijing) Limited, Beijing (CN)

(72) Inventor: Changsen FU, Beijing (CN)

(21) Appl. No.: 19/661,936

(22) Filed: Apr. 29, 2026

(30) Foreign Application Priority Data
Apr. 30, 2025 (CN) 202510573038.6

(51) Int. Cl. G10L 13/04; G10L 13/027

(52) U.S. Cl. CPC G10L 13/04; G10L 13/027

(57) ABSTRACT

A voice interaction method includes in response to obtaining a target voice corresponding to an object, obtaining multimodal information corresponding to the object, generating voice style prompt information corresponding to the object based on the multimodal information using a preset style generation model, and generating a reply voice corresponding to the target voice based on the voice style prompt information.

### CROSS-REFERENCE TO RELATED APPLICATION

This application claims priority to Chinese Patent Application No. 202510573038.6, filed on Apr. 30, 2025, the entire content of which is incorporated herein by reference.

### TECHNICAL FIELD

The present disclosure generally relates to the field of voice interaction technology and, more particularly, to a voice interaction method and device.

### BACKGROUND

With the rapid development of Artificial Intelligence (AI) technology, intelligent assistants are increasingly widely used on personal computers (PCs), and voice plays an important role in intelligent assistant interaction systems, which can greatly improve the user's interactive experience. In commonly used voice interaction systems, Text-to-Speech (TTS) can generate various voice styles, accents, laughter, etc., according to user needs. However, users need to pre-set relevant style information. In actual AI experiences on a PC, different generation styles need to be repeatedly specified when switching between different users, especially in multi-user scenarios where user switching is more frequent. Repeatedly specifying generation styles makes voice interaction cumbersome and inefficient.

### SUMMARY

In accordance with the present disclosure, there is provided a voice interaction method including in response to obtaining a target voice corresponding to an object, obtaining multimodal information corresponding to the object, generating voice style prompt information corresponding to the object based on the multimodal information using a preset style generation model, and generating a reply voice corresponding to the target voice based on the voice style prompt information.

Also in accordance with the present disclosure, there is provided a voice interaction device including a sensor configured to obtain multimodal information corresponding to an object in response to obtaining a target voice corresponding to the object, and a processor configured to generate voice style prompt information corresponding to the object based on the multimodal information using a preset style generation model, and generate a reply voice corresponding to the target voice based on the voice style prompt information.

Also in accordance with the present disclosure, there is provided a non-transitory computer-readable storage medium storing instructions that, when executed by a processor, cause an electronic device including the processor to in response to obtaining a target voice corresponding to an object, obtain multimodal information corresponding to the object, generate voice style prompt information corresponding to the object based on the multimodal information using a preset style generation model, and generate a reply voice corresponding to the target voice based on the voice style prompt information.

### BRIEF DESCRIPTION OF THE DRAWINGS

To more clearly illustrate the technical solutions in the embodiments of the present disclosure, the drawings used in the following description of the embodiments will be briefly introduced. Obviously, the drawings described below are only some embodiments of the present disclosure. For those skilled in the art, other drawings can be obtained based on these drawings without creative effort.

FIG. 1 is a flowchart of a voice interaction method in related technologies.

FIG. 2 is a flowchart of a voice interaction method consistent with the present disclosure.

FIG. 3 is a flowchart of a method for generating voice style prompt information consistent with the present disclosure.

FIG. 4 is a flowchart of another method for generating voice style prompt information consistent with the present disclosure.

FIG. 5 is a flowchart of another method for generating voice style prompt information consistent with the present disclosure.

FIG. 6 is a flowchart of a method for generating user labels consistent with the present disclosure.

FIG. 7 is a flowchart of a feature extraction method consistent with the present disclosure.

FIG. 8 is a flowchart of another method for generating user labels consistent with the present disclosure.

FIG. 9 schematically shows a network structure of generating user labels consistent with the present disclosure.

FIG. 10 is a flowchart of a reply voice generation method consistent with the present disclosure.

FIG. 11 schematically shows another network structure of generating user labels consistent with the present disclosure.

FIG. 12 is a flowchart of another reply voice generation method consistent with the present disclosure.

FIG. 13 is a flowchart of a method for matching voice style prompt information consistent with the present disclosure.

FIG. 14 is a flowchart of a model training method consistent with the present disclosure.

FIG. 15 is a flowchart of a voice interaction method consistent with the present disclosure.

FIG. 16 is a structural diagram of a voice interaction device consistent with the present disclosure.

### DETAILED DESCRIPTION OF THE EMBODIMENTS

The technical solutions in the embodiments of the present disclosure will be described below with reference to the accompanying drawings. It is understood that the specific embodiments described herein are merely for explaining the relevant disclosure and are not intended to limit the present disclosure. It should also be noted that, for ease of description, only the parts relevant to the present disclosure are shown in the accompanying drawings.

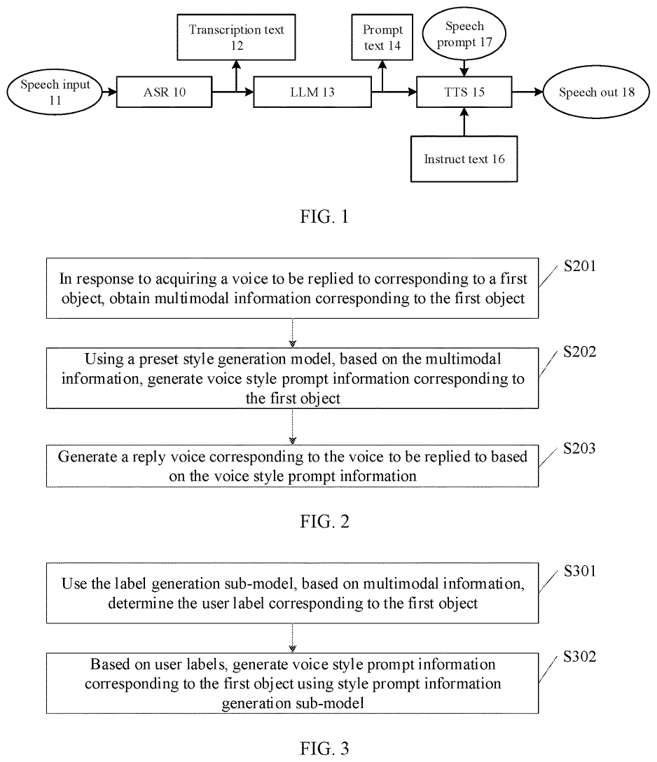

In related technologies, commonly used voice interaction systems are implemented using paradigms such as Automatic Speech Recognition (ASR), Large Language Model (LLM), and Text-to-Speech (TTS). A paradigm flow is shown in FIG. 1, where ASR 10 recognizes the speech input 11 as transcription text 12, LLM 13 generates prompt text 14 based on the transcription text 12, and TTS 15 combines the instruct text 16 and the speech prompt 17 to generate speech out 18 from the prompt text 14.

In terms of TTS (Text-to-Speech), related technologies can generate various voice styles according to user needs, including accents, laughter, and other information. This is achieved by inserting tokens at different positions in the LLM output prompt text. Instruct text is user's specified dialect, tone, intonation, and other stylistic preferences. Acoustic feature information such as speech prompt is provided through a speech prompt. However, the methods for controlling the TTS generation style need users to pre-set the relevant instruct text. In actual AI experiences on a PC, different generation styles need to be repeatedly specified when switching between different users. This is especially problematic in home use scenarios where user switching is more frequent, and repeatedly specifying generation styles significantly impacts the user experience. Currently, there is no solution to this problem.

The present disclosure provides a voice interaction method implemented by a voice interaction device, as shown in FIG. 2, including the following.

At S201, in response to acquiring a voice to be replied to corresponding to a first object, multimodal information corresponding to the first object is obtained. The voice to be replied to is also referred to as a “target voice.”

Consistent with the present disclosure, the voice interaction device is an electronic device with voice interaction functionality, such as a tablet computer, laptop computer, Personal Digital Assistant (PDA), desktop computer, etc. No specific limitation is made to the voice interaction device here.

Consistent with the present disclosure, the voice interaction device can acquire the voice to be replied to corresponding to a first object through a sound acquisition sensor. For example, the sound acquisition sensor can be a microphone or microphone array.

Consistent with the present disclosure, if the voice interaction device acquires the voice to be replied to corresponding to a first object, the voice interaction device can acquire multimodal information such as image information, identification information, voice information, and distance corresponding to the first object through various sensors.

For example, the voice interaction device can acquire the multimodal information corresponding to the first object through a microphone, camera, infrared sensor, radar, text input, or thermal imaging sensor.

Consistent with the present disclosure, the first object can be any object within the voice range that the voice interaction device can receive, or an object within a preset distance of the voice interaction device, or an object using the voice interaction device.

At S202, using a preset style generation model, based on the multimodal information, voice style prompt information corresponding to the first object is generated.

In embodiments of the present disclosure, after obtaining the multimodal information of a first object, the voice interaction device uses a preset style generation model to generate corresponding voice style prompt information based on the multimodal information.

In embodiments of the present disclosure, the preset style generation model can be a generative pre-trained Transformer (GPT) model based on a decoder-only Transformer architecture. In some embodiments, the preset style generation model can also be other deep learning generative models, such as autoregressive models, deep learning models based on self-attention mechanisms, or other models capable of generating voice style prompt information based on multimodal information.

In embodiments of the present disclosure, the preset style generation model is a model capable of automatically generating matching voice style prompt information based on multimodal information. For example, the voice style prompt information can be “Please say this sentence using XX tone, XX dialect, XX speaking speed,” or “Please say this sentence using XX timbre, XX accent, XX tone,” etc. The information involved in the voice style prompt information can be set according to actual needs and application scenarios. The present disclosure does not impose any limitations on this.

For example, if the first object's voice to be replied to uses an accent of type A, the first object is currently in a very happy mood, and the first object is between 60 and 70 years old, then the corresponding voice style prompt could be, “Please say this sentence in a happy tone and with an accent of type A, and speak slowly for better clarity.”

For example, if the first object's voice to be replied to uses an accent of type B, the first object is currently in a very cute tone, and the first object is between 3 and 5 years old, then the corresponding voice style prompt could be, “Please say this sentence in an S-type timbre, with an accent of type B, and in a cute tone.”

At S203, a reply voice corresponding to the voice to be replied to is generated based on the voice style prompt information.

Consistent with the present disclosure, the voice interaction device can generate a reply voice corresponding to the voice to be replied to after obtaining the voice style prompt information.

Consistent with the present disclosure, the voice interaction device can perform speech recognition on the voice to be replied to, generate transcription text, then generate corresponding prompt text based on the transcription text, and finally convert the prompt text into voice output using the voice style prompted by the voice style prompt information.

Compared to related technologies that need repeatedly specifying the generated style when switching users, the present disclosure automatically generates voice style prompt information matching the user based on multimodal information, simplifying the user's voice interaction process and improving the user's voice interaction experience.

In some embodiments, the preset style generation model includes a label generation sub-model and a style prompt information generation sub-model. When performing process S202, as shown in FIG. 3, the voice interaction device further performs the following processes S301 and S302.

At S301, the user label corresponding to the first object is determined based on multimodal information using the label generation sub-model.

Consistent with the present disclosure, the label generation sub-model can be an intelligent perception model. Using the intelligent perception model, based on multimodal information, tasks such as identity recognition, distance perception, dialect prediction, and age prediction can be performed on the first object, and corresponding user labels can be generated.

For example, user labels can be saved in JSON format, such as {“user_id”: 1, “emotion”: happy, “dialect”: B accent, “distance”: 1000, “age”: 20~25}.

At S302, based on user labels, voice style prompt information corresponding to the first object is generated using style prompt information generation sub-model.

Consistent with the present disclosure, user labels are relatively discrete prompt label words. The voice interaction device generates a sub-model using style prompt information. Based on these relatively discrete prompt label words, the text content of the output voice style prompt information becomes richer, more diverse, and more natural and fluent.

For example, the style prompt information generation sub-model can be a language model (LM), such as a neural network-based language model: Recurrent Neural Network (RNN), Long Short-Term Memory (LSTM), Transformer, etc.

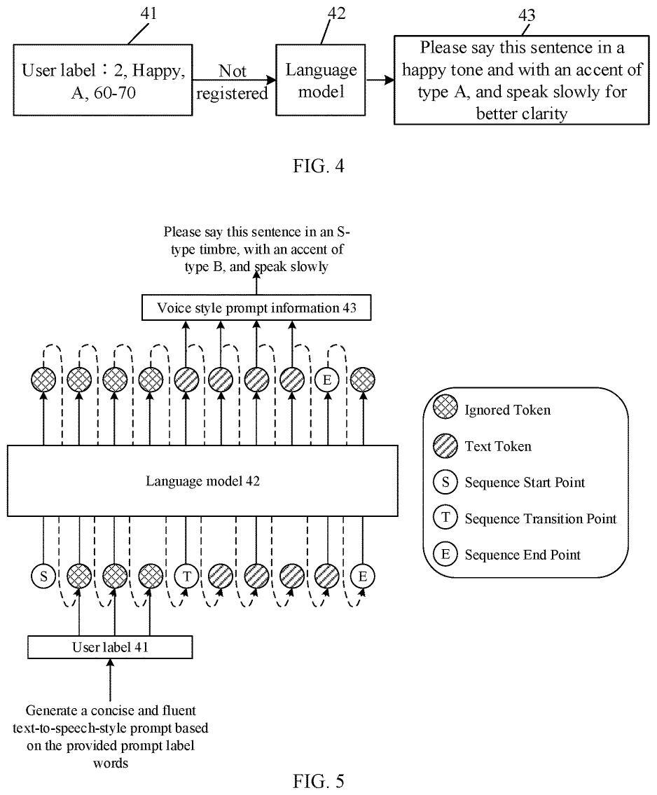

As shown in FIG. 4, a flowchart for generating voice style prompt information is provided. User label 41 is input into the language model 42 to generate voice style prompt information 43 corresponding to the first object.

As shown in FIG. 5, a network structure of a language model is provided. Relatively discrete prompt label words (key words), i.e., user label 41, is input into the language model 42 to generate voice style prompt information 43 corresponding to the first object. In some embodiments, language model 42 employs an autoregressive Transformer structure, where S represents the sequence start point, T represents the sequence transition point, E represents the sequence end point, the diagonal cross is the ignored token, and the diagonal line is the text token.

In some embodiments, the voice style prompt information generated based on multimodal information, along with the user-defined input style prompts and LLM-generated content in voice interaction, are all natural language, exhibiting high consistency and facilitating TTS model understanding and reasoning.

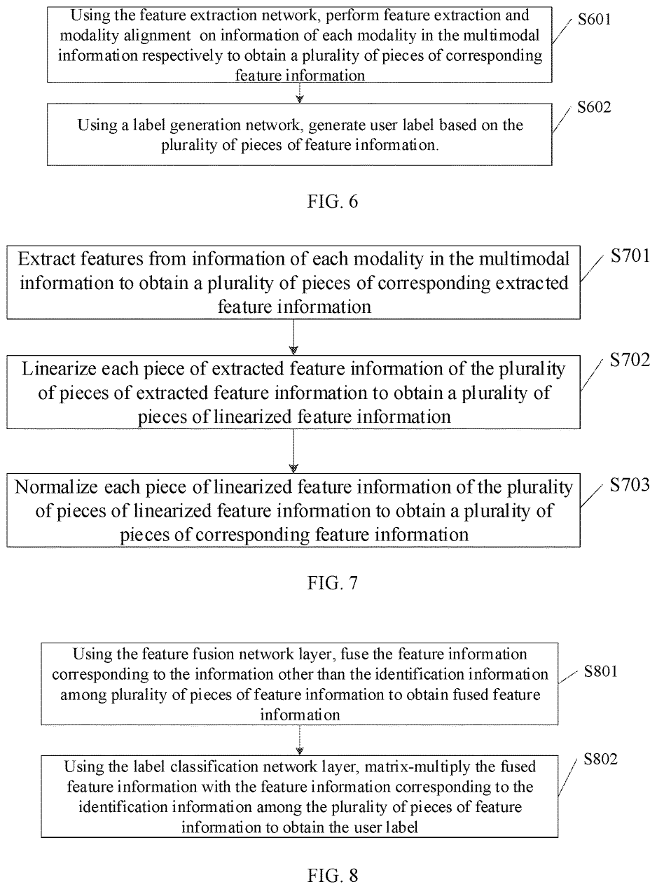

In some embodiments, the label generation sub-model includes a feature extraction network and a label generation network. When performing process S301, as shown in FIG. 6, the voice interaction device further performs the following processes S601 and S602.

At S601, using the feature extraction network, feature extraction and modality alignment are performed on information of each modality in the multimodal information respectively to obtain a plurality of pieces of corresponding feature information.

In some embodiments, the label generation sub-model includes a feature extraction network and a label generation network. The voice interaction device performs feature extraction and modality alignment on each multimodal information to obtain a plurality of pieces of corresponding feature information.

In embodiments of the present disclosure, the voice interaction device extracts features from each of the multimodal information. For example, the multimodal information may include text information, voice information, and image information. The feature extraction network can extract multiple extracted features; for example, text information corresponds to text extracted features, voice information corresponds to voice extracted features, and image information corresponds to image extracted features. Considering the different dimensions of text extracted features, voice extracted features, and image extracted features, modality alignment is performed on the obtained multiple extracted features to obtain plurality of pieces of feature information.

At S602, using a label generation network, user labels are generated based on the plurality of pieces of feature information.

In embodiments of the present disclosure, the voice interaction device uses a label generation network to generate user labels based on the plurality of pieces of feature information.

Thus, user labels can be generated from multimodal information based on the feature extraction network and the label generation network. These user labels match a first object, and the voice style prompt information determined based on the user labels also match the first object, resulting in greater flexibility.

In some embodiments, when performing process S601, as shown in FIG. 7, the voice interaction device further performs processes S701 to S703.

At S701, features are extracted from information of each modality in the multimodal information to obtain a plurality of pieces of corresponding extracted feature information.

For example, the multimodal information may include text information, voice information, and image information. The text information, voice information, and image information are represented as: T∈ [symbol] , A∈ [symbol] , I∈ [symbol] . Then, features are extracted using three feature extraction networks.

For example, the extraction method for text information is shown in equation (1):

T_{f}=Text_Encoder(T) (1);

where T_{f} is the extracted feature information corresponding to the text information, Text_Encoder is the text extraction network, and the feature dimension of T_{f} is [symbol] .

For example, the extraction method for voice information is shown in equation (2):

A_{f}=Audio_Encoder(A) (2);

where A_{f} is the extracted feature information corresponding to the voice information, Audio_Encoder is the speech extraction network, and the feature dimension of A_{f} is [symbol] .

For example, the extraction method for image information is shown in equation (3):

I_{f}=Image_Encoder(I) (3);

Where I_{f} is the extracted feature information corresponding to the image information, Image_Encoder is the image extraction network, and the feature dimension of I_{f} is [symbol] . Where N is mini_batch_size (size of mini batch), which can be understood as the number of classification labels and users, and d is the feature dimension of each batch.

Based on the different dimensions of the text extracted feature information for text, image extracted feature information, and voice extracted feature information, modality alignment, such as linearization, and normalization will be performed on these extracted feature information for better feature fusion.

At S702, each piece of extracted feature information of the plurality of pieces of extracted feature information is linearized to obtain plurality of pieces of linearized feature information.

Consistent with the present disclosure, the voice interaction device linearizes each of the plurality of pieces of extracted feature information: text extracted feature information, image extracted feature information, and voice extracted feature information to obtain plurality of pieces of linearized feature information.

For example, the linearization equation is shown in equation (4):

e=Linear_{T}(X) (4);

Where X can be text extracted feature information, image extracted feature information, and voice extracted feature information, Linear_{T} is the linearization algorithm, and e is the linearization result.

At S703, each piece of linearized feature information of the plurality of pieces of linearized feature information is normalized to obtain a plurality of pieces of corresponding feature information.

Consistent with the present disclosure, the voice interaction device normalizes each of the plurality of pieces of linearized feature information: text linearized feature information, image linearized feature information, and voice linearized feature information to obtain multiple normalized feature information.

For example, the implementation of modality alignment for plurality of pieces of extracted feature information can be found in the following equations (5) to (7):

For example, the modality alignment method for extracted text feature information is in equation (5):

Tₑ=L₂_norm(Linear_{T}(T_{f}))=L₂_norm(W_{T}T_{f}+b_{T}) (5);

Where, Tₑ is the text feature information, W_{T} and b_{T} are model parameters.

For example, the modality alignment method for extracted voice feature information is in equation (6):

Aₑ=L₂_norm(Linear_{A}(A_{f}))=L₂_norm(W_{A}A_{f}+b_{A}) (6);

Where, Aₑ is the voice feature information, W_{A} and b_{A} are model parameters.
For example, the modality alignment method for extracting feature information from an image is shown in equation (7):

Iₑ=L₂_norm(Linear_{I}(I_{f}))=L₂_norm(W_{I}I_{f}+b_{I}) (7);

Where Iₑ is the voice feature information, and W_{I} and by are model parameters.

Thus, the feature dimension of all the above-mentioned feature information is [symbol] .

This ensures a unified processing method among multiple modal information, facilitates the fusion of multiple modal information, extracts the relationship information of each piece of information, and improves the accuracy of speech style prompts determined based on multimodal information.

In some embodiments, the multimodal information includes identification information, and at least one of image information and voice information; the label generation network includes a feature fusion network layer and a label classification network layer. When performing process S602 above, as shown in FIG. 8, the voice interaction device further performs the following processes S801 and S802.

At S801, Using the feature fusion network layer, the feature information corresponding to the information other than the identification information among plurality of pieces of feature information is fused to obtain fused feature information.

Consistent with the present disclosure, the voice interaction device uses the feature fusion network layer to fuse the feature information corresponding to the information other than the identification information among plurality of pieces of feature information to obtain fused feature information.

For example, the identification information may exist in the form of text information. The feature fusion network layer can fuse image feature information and voice feature information, or one of image feature information and voice feature information. When a certain feature information is not included, a preset value is input, indicating that the current feature information is not involved.

For example, among plurality of pieces of feature information, the feature information corresponding to information other than the identification information may include image feature information and voice feature information. The method for feature fusion of image feature information and voice feature information is shown in equation (8):

Fₑ=Aₑ+Iₑ (8);

Where Fₑ is the fused feature information.

At S802, Using the label classification network layer, the fused feature information is matrix-multiplied with the feature information corresponding to the identification information among the plurality of pieces of feature information to obtain the user label.

Consistent with the present disclosure, the voice interaction device uses the label classification network layer to matrix-multiply the fused feature information with the feature information corresponding to the identification information to obtain the user label.

For example, the method for determining the user label is shown in equation (9):

$$C = τ * ( {T}_{e} \cdot {F}_{e}^{T} ) ; \qquad ( 9 )$$

Where C is the similarity matrix, C∈ [symbol] , and the diagonal of the matrix represents the category label (user label) corresponding to the multimodal information.

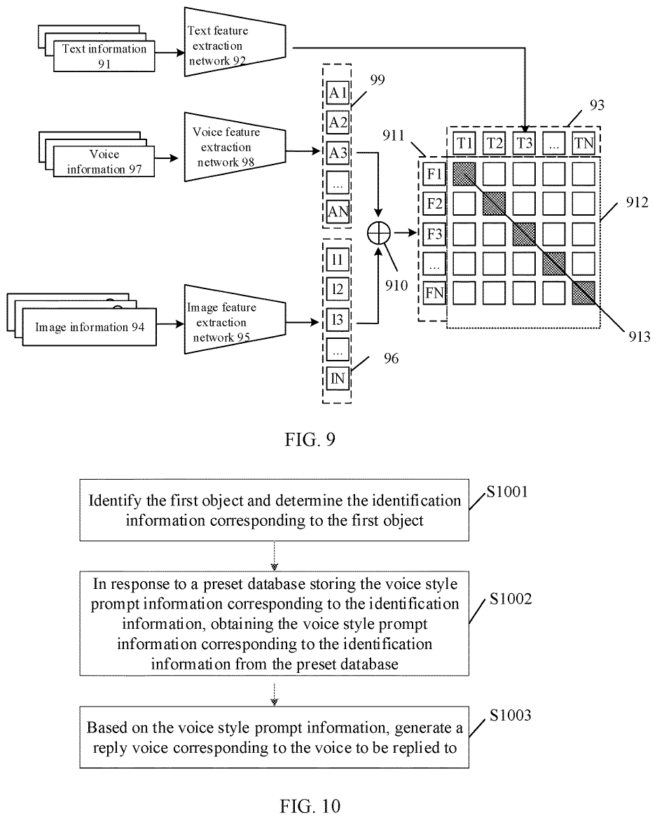

As shown in FIG. 9, an implementation for generating user labels is provided. The voice interaction device inputs text information (identification information) 91 into a text feature extraction network (Text Encoder) 92 to obtain text feature information 93, inputs image information 94 into an image feature extraction network (Image Encoder) 95 to obtain image feature information 96, and inputs voice information 97 into an voice feature extraction network (Audio Encoder) 98 to obtain voice feature information 99. Then, the image feature information 96 and the voice feature information 99 are input into a feature fusion network layer 910 to obtain fused feature information 911. Finally, the fused feature information 911 and the text feature information 93 are input into a label classification network layer 912 to obtain user labels 913. In the figure, the diagonal lines (gray squares) represent positive samples, i.e., user labels.

In some embodiments, as shown in FIG. 10, the voice interaction device further performs the following processes S1001 to S1003.

At S1001, identify the first object and determine the identification information corresponding to the first object.

Consistent with the present disclosure, the voice interaction device performs identity recognition on a first object to determine the identification information corresponding to the first object. At this time, the voice interaction device can obtain the voice to be replied to corresponding to the first object, and then perform identity recognition based on the voice to be replied to.

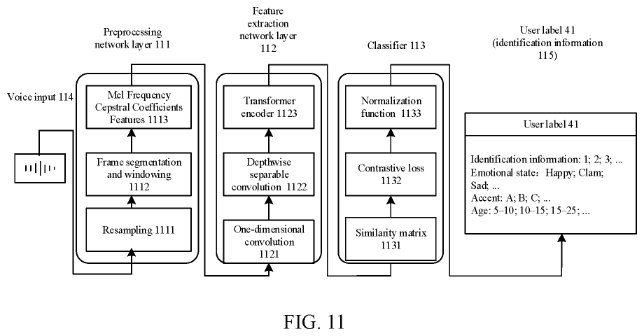

As shown in FIG. 11, the voice interaction device is a network structure of image-text (Clip) and voice-text (Clap) (Clip-Clap Net, CCNet), including: a preprocessing network layer 111, a feature extraction network layer 112, and a classifier 113. The preprocessing network layer 111 includes resampling 1111, frame segmentation and windowing 1112, and MFCC features (Mel Frequency Cepstral Coefficients) 1113. The feature extraction network layer 112 includes a one-dimensional convolution 1121, a depthwise separable convolution 1122, and a transformer encoder 1123. The classifier 103 includes a similarity matrix 1131, a contrastive loss 1132, and a normalization function (Softmax) 1133. The voice to be replied to 114 is input into this structure to obtain the identification information 115 of the first object, including information such as the first object's current mood, accent, and age.

FIG. 11 illustrates the voice input processing method. Employing contrastive learning method, the voice input processing method possesses superior feature representation and generalization capabilities, enabling more effective user identity classification. The CCNet network structure is shown in FIG. 11, where the Text Encoder, Audio Encoder, and Image Encoder are all based on the Transformer network structure. Each encoder uses a specific feature extraction network for each modality to improve consistency during subsequent feature fusion and facilitate model training. This section illustrates the processing method for voice input. Image input processing methods may also be illustrated. The configuration of the preprocessing network layers refers to the network layers involved in image preprocessing, while the configuration of the feature extraction network layers refers to network layers dedicated to extracting image features-such as 2D convolutional layers. Similarly, the configuration of the classifier follows the same principles as the image processing methodology, and contrastive learning could be employed to determine the user label corresponding to the image information.

At S1002, in response to a preset database storing the voice style prompt information corresponding to the identification information, the voice style prompt information corresponding to the identification information are retrieved from the preset database.

In some embodiments, if the preset database includes voice style prompt information corresponding to the identification information, the voice interaction device can directly retrieve the corresponding voice style prompt information from the preset database.

At S1003, based on the voice style prompt information, a reply voice corresponding to the voice to be replied to is generated.

In some embodiments, if the preset database includes voice style prompt information, the reply voice corresponding to the voice to be replied to is generated directly based on the voice style prompt information.

Thus, if the preset database stores the voice style prompt information corresponding to the first object, the voice style prompt information can be used directly without generation, thereby reducing the time needed to generate voice style prompt information and improving the efficiency of voice interaction.

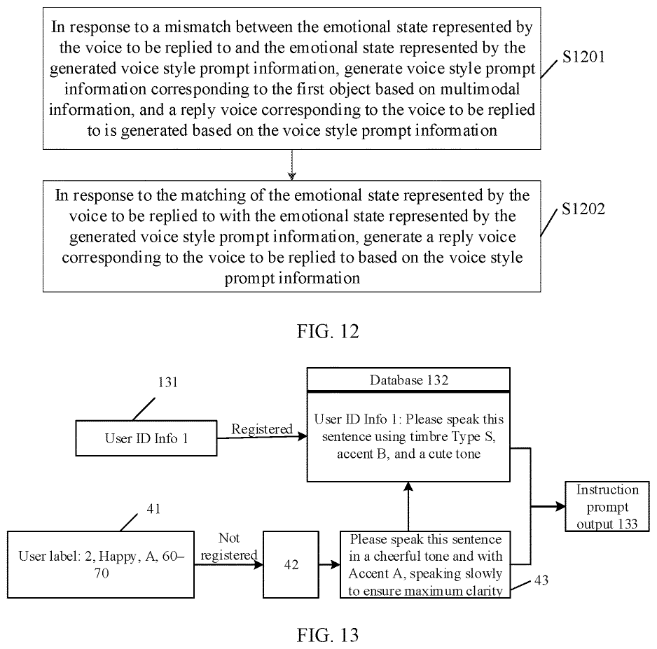

In some embodiments, after performing the above process S1002 of “obtaining the voice style prompt information corresponding to the identification information from the preset database,” as shown in FIG. 12, the voice interaction device further performs the following processes S1201 and S1202.

At S1201, In response to a mismatch between the emotional state represented by the voice to be replied to and the emotional state represented by the generated voice style prompt information, voice style prompt information corresponding to the first object is generated based on multimodal information, and a reply voice corresponding to the voice to be replied to is generated based on the voice style prompt information.

Consistent with the present disclosure, the voice style prompt information includes the user's current emotional state. After obtaining the voice style prompt information, the voice interaction device will further determine whether the emotional state represented by the voice to be replied to matches the emotional state represented by the generated voice style prompt information. If the emotional state represented by the voice to be replied to does not match the emotional state represented by the generated voice style prompt information, the voice interaction device will generate voice style prompt information corresponding to the first object based on multimodal information, and a reply voice corresponding to the voice to be replied to is generated based on the voice style prompt information.

Therefore, by further considering the matching of the user's emotional state, the matching degree between the voice style prompt information and the first object is improved. Then, the determined voice style prompt information is more accurate, and the reply voice determined based on the voice style prompt information is also more accurate.

At S1202, In response to the matching of the emotional state represented by the voice to be replied to with the emotional state represented by the generated voice style prompt information, a reply voice corresponding to the voice to be replied to is generated based on the voice style prompt information.

Consistent with the present disclosure, if the emotional state represented by the voice to be replied to matches the emotional state represented by the generated voice style prompt information, a reply voice corresponding to the voice to be replied to is directly generated based on the voice style prompt information.

Thus, after the voice style prompt information corresponding to the identification information is found, whether the emotional state is consistent with the voice style prompt information will be further determined. This results in more accurate voice style prompt information and more intelligent voice interaction.

In some embodiments, after performing the process “generating voice style prompt information corresponding to the first object” in the above-described processes, the voice interaction device may further perform the following processes: establishing a correspondence between the identification information corresponding to the first object and the voice style prompt information, and storing the established correspondence in a preset database. The identification information includes the identity information of the first object.

In embodiments of the present disclosure, the identification information includes the identity information of the first object, such as: username, ID number, a number assigned to represent identity, etc. In some embodiments, the identification information can also be other information representing user identity, user biometrics, or others.

In embodiments of the present disclosure, the above-described process S1001 performs user identity recognition on the first object. Besides recognition based on the voice to be replied to, recognition can also be based on the first object's facial features, obtained user biometrics, or the identity information input by the user.

In embodiments of the present disclosure, the voice interaction device establishes a correspondence between the identification information corresponding to the first object and the voice style prompt information, and stores the established correspondence in a preset database.

For example, as shown in FIG. 13, based on the label results (identification information) identified by intelligent perception, conditional judgments are made. When it is identified that the speaker (first object) 131 has registered in the preset database (database) 132, the corresponding prompt instruction (voice style prompt information) and speech prompt (instruction prompt output) 133 are directly extracted. When it is identified that the speaker 132 has not yet registered in the preset database 132, information such as dialect, age, and timbre (user labels) 41 are input to the LM 42 to generate prompt text (voice style prompt information) 43.

Consistent with the present disclosure, the voice interaction device can also set multiple corresponding voice style prompt information for the same user. For example, a corresponding voice style prompt information can be set for different emotional states of the same user, or for different accents of the same user's emotions, or for different languages. voice style prompt information will be more accurate.

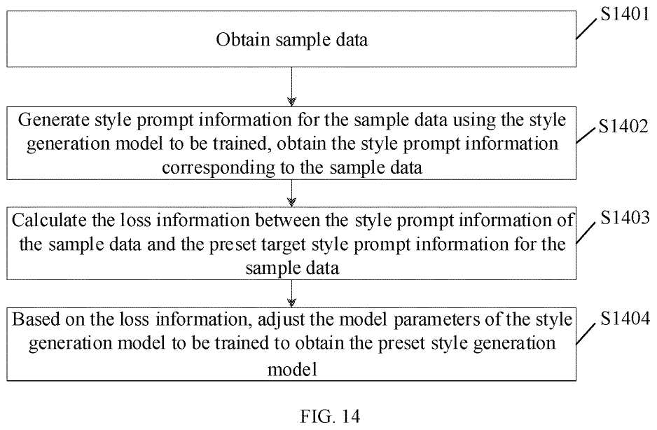

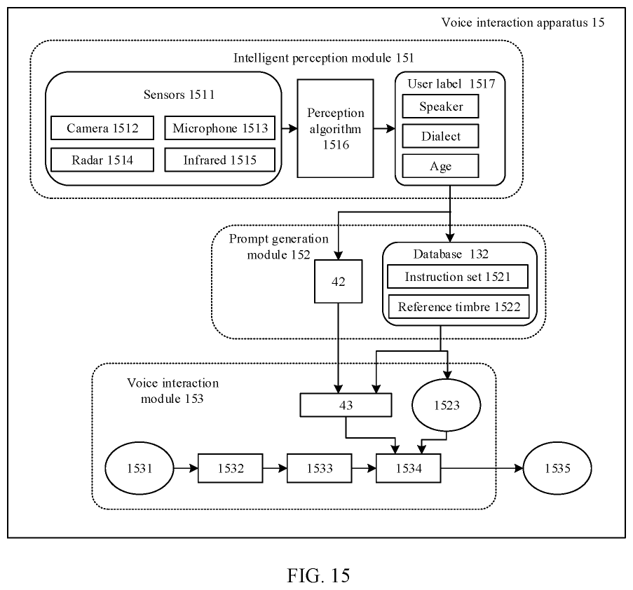

In some embodiments, as shown in FIG. 14, the voice interaction device further performs the following processes S1401 to S1404.

At S1401, sample data is obtained.

Consistent with the present disclosure, the sample data can be multimodal sample data.

At S1402, style prompt information for the sample data is generated using the style generation model to be trained to obtain the style prompt information corresponding to the sample data.

Consistent with the present disclosure, the style generation model to be trained (also referred to as an “initial style generation model”) has the same network structure as the preset style generation model. The voice interaction device uses the style generation model to be trained to generate style prompt information for the sample data, and obtain the style prompt information corresponding to the sample data.

At S1403, the loss information between the style prompt information of the sample data and the preset target style prompt information for the sample data is calculated.

Consistent with the present disclosure, the voice interaction device can calculate the loss information between the style prompt information of the sample data and the preset voice style prompt information for the sample data.

At S1404, based on the loss information, the model parameters of the style generation model to be trained is adjusted to obtain the preset style generation model.

Consistent with the present disclosure, based on the loss information, adjust the network parameters in the style generation model to be trained to obtain the preset style generation model.

In embodiments of the present disclosure, the style generation model to be trained includes a label generation sub-model to be trained and a style prompt generation sub-model to be trained. The label generation sub-model to be trained and the style prompt generation sub-model to be trained can be trained together as described in processes S1401 to S1404, or the label generation sub-model to be trained and the style prompt generation sub-model to be trained can be trained separately.

For example, when sample data is input into the label generation sub-model to be trained, user sample labels are obtained. The voice interaction device determines the cross-entropy loss information between the user sample labels and the preset user target labels for the sample data. Based on the cross-entropy loss information, the model parameters of the label generation sub-model to be trained are adjusted to obtain the preset label generation sub-model.

For example, the method for determining the loss information between user sample labels and preset user target labels for sample data is shown in equation (10):

$$ℒ = 0. 5 * ( {ℓ}_{text} ( C ) + {ℓ}_{fusion} ( C ) ) ; \qquad ( 10 )$$

Where, [symbol] and [symbol] represent the cross-entropy loss information on different dimensions of the similarity matrix C, mathematically represented as follows (see equations (11) and (12):

$${ℓ}_{text} = \frac{1}{N} {\sum }_{i = 0}^{N} log diag ( softmax ( {C}_{: , i} ) ) ; \qquad ( 11 )$$

$${ℓ}_{fusion} = \frac{1}{N} {\sum }_{i = 0}^{N} log diag ( softmax ( {C}_{i , :} ) ) ; \qquad ( 12 )$$

Thus, the model parameters can be adjusted based on the cross-entropy loss information to obtain the preset label generation sub-model.

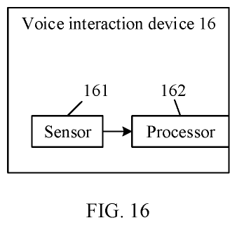

For example, FIG. 15 is a flowchart of a voice interaction method. As shown in FIG. 15, the voice interaction method can be implemented on a voice interaction apparatus 15. The voice interaction apparatus 15 includes an intelligent perception module 151, a prompt generation module 152, and a voice interaction module 153. In the present disclosure, the voice interaction method is discussed in conjunction with the voice interaction apparatus 15. For example, the voice interaction method includes the following processes S1501 to S1503.

At S1501, Determine the user label.

In the present disclosure, the voice interaction apparatus 15 obtains the multimodal information of the user (the first object) through sensors 1511, such as camera 1512, microphone 1513, radar 1514, and infrared 1515. The multimodal information is input into the perception algorithm 1516 to obtain the user label 1517. That is, the intelligent perception module 151 obtains the user's multimodal information and generates the user label 1517. The multimodal scene perception system includes multiple sensors mounted at an AI PC, such as camera, microphone, and radar. Based on the multimodal information extracted by the sensors, identity verification and scene perception can be jointly performed.

At S1502, Determine the voice style prompt information.

In the present disclosure, the voice interaction apparatus 15 matches the corresponding voice style prompt information from the database (preset database) 132 based on the user label 1517. If no such information is found, voice style prompt information is generated via LM 42. Specifically, for voice style prompt information (instruction set) 1521 involving speech prompt 1522, the corresponding target speech prompt 1523, such as an S-type timbre, also needs to be obtained. The matching method from the preset database can be based on the identification information in the user label, or the identification information together with the emotional state in the user label, etc., or all information involved in the entire user label, or even just some information in the user label. The matching can be determined based on the correspondence in the preset database. That is, the prompt generation module 152 generates prompt instructions (voice style prompt information) 43 based on the user label 41. Based on the label output results of the intelligent perception module 151, the model can generate corresponding style prompt sentences. If the user has registered, the matching style prompt is extracted from the database; if the user requests a speech prompt, the database provides the corresponding timbre. By adaptively generating style prompts, the operations needed to change the voice synthesis style when the user changes can be effectively reduced, improving the usability of the voice interaction system.

At S1503, Output the reply voice.

In the present disclosure, the voice to be replied to 1531 is input to the voice recognition model 1532 via the voice interaction module 153 to generate transcription text. This transcription text is then input to the large language model 1533, the large language model 1533 generates the corresponding prompt text based on the transcription text. The voice synthesis model 1534 generates the voice response 1535 based on the prompt text, prompts (voice style prompt information) 43, and the target timbre reference 1523. The voice interaction module includes ASR, LLM, and TTS. TTS can generate a voice synthesis style that matches the user's expectations based on the style prompts and speech prompt. Style switching can be seamless when the user changes. This solution is independent of existing voice interaction systems and can be used without retraining the original voice interaction system, exhibiting high adaptability and a wider range of application scenarios.

An implementation of voice interaction is as follows: A perception algorithm performs user identification recognition using the network structure shown in FIG. 11, combining voiceprint and facial multimodal information for detection. Different users are assigned different ID labels (identification information). When an ID is not registered, the subsequent prompt generation module generates a style prompt sentence and binds the style prompt sentence to the ID, storing the style prompt sentence and the ID in a database (preset database) as an instruction set (voice style prompt information). When an ID is registered, the corresponding style prompt sentence (voice style prompt information) is directly extracted from the database without further label prediction, thus reducing latency and improving user experience. Further, a deep learning network model is used to perform tasks such as emotion recognition, dialect prediction, and age prediction, generating corresponding labels. Different labels can control different style dimensions. For example, dialect controls the generated accent, making it easier for users to understand and the generated content more friendly; user age controls the generated speech rate; and distance can be used via post-processing to control the volume of the voice playback.

The prompt generation module includes two parts: a language model (LM) and a database. The language model, based on a decoder-only Transformer architecture, generates natural language prompt text based on input labels. The database includes registered and saved instruction sets and speech prompts. Compared to discrete prompt labels, the prompt sentences generated by the LM are richer, more diverse, and more natural and fluent. The prompt sentences generated by the LM are consistent with user-defined style prompts and LLM-generated content in voice interaction, all being natural language, thus facilitating TTS model understanding and inference.

Consistent with the present disclosure, both the intelligent perception module and the style prompt generation module are trained and inferred locally on the AI PC. User personal information, such as facial features and voice, is stored locally, ensuring user privacy and security even when using a cloud-based voice interaction module.

After acquiring the voice to be replied to corresponding to the first object, conditional judgment is first performed on the label results identified by the intelligent perception module. If the speaker is identified as registered in the database, the corresponding prompt instruction and speech prompt are directly extracted and output to the downstream TTS model. If the speaker is not identified as registered in the database, information such as dialect, age, and timbre is input into the LM to generate the prompt text. This module includes a voice recognition model, a large language model and a voice generation model. The voice recognition model converts user speech input into text. The large language model generates a response based on the text. The voice synthesis model generates different styles of speech based on the prompt text, prompts provided by the prompt generation module, and reference speech. The specific input to the voice synthesis model can be represented as the following.

<soi> Please use an S-type timbre, a B-type accent, and say this sentence slowly. <sot> Nice to meet you!<laughter><sosp> Speech prompt<sos> Speech out<eos>;

<soi> represents the start of the instruction, <sot> represents the start of the text, <laughter> represents the inserted emotion label, <sosp> represents the reference speech (in this example, an S-type timbre), <sos> represents the start of the speech, and <eos> represents the end of the speech.

Therefore, the present disclosure provides a voice interaction method based on intelligent scene perception, aiming to adjust the TTS generation style in real time and adaptively according to the user's identity and usage scenario. Users only need to set a style once for registration, and the style will be automatically invoked in every subsequent conversation, improving multi-user experience. Furthermore, for unregistered users, the intelligent perception system will automatically generate appropriate voice style prompt information. The embodiments of the present disclosure can be widely applied to intelligent voice interaction scenarios, simplifying the user's voice interaction process and improving the user experience of AI PC-side voice interaction, thus possessing high practical value.

The present disclosure provides a voice interaction method, including: responding to a acquired voice to be replied to corresponding to a first object, obtaining multimodal information corresponding to the first object; using a preset style generation model, generating voice style prompt information corresponding to the first object based on the multimodal information; and generating a reply voice corresponding to the voice to be replied to based on the voice style prompt information. The voice interaction method provided by the present disclosure, based on multimodal information, automatically generates voice style prompt information matching the user, simplifying the user's voice interaction process and improving the user's voice interaction experience.

The present disclosure provides a voice interaction device 16, as shown in FIG. 16, including: a sensor 161 and a processor 162.

The sensor 161 is used to obtain multimodal information corresponding to the first object in response to the acquired voice to be replied to corresponding to the first object.

The processor 162 is used to generate voice style prompt information corresponding to the first object based on the multimodal information using a preset style generation model; and generate a reply voice corresponding to the voice to be replied to based on the voice style prompt information.

In some embodiments, the preset style generation model includes a label generation sub-model and a style prompt information generation sub-model. The processor 162 is further used to determine the user label corresponding to the first object based on the multimodal information using the label generation sub-model; and to generate the voice style prompt information corresponding to the first object based on the user label using the style prompt information generation sub-model.

In some embodiments, the processor 162 is further used to establish a correspondence between the identification information corresponding to the first object and the voice style prompt information, and to store the established correspondence in a preset database. The identification information includes the identity information of the first object.

In some embodiments, the label generation sub-model includes: a feature extraction network and a label generation network. The processor 162 is further configured to use the feature extraction network to perform feature extraction and modality alignment on information of each modality in the multimodal information, obtaining corresponding plurality of pieces of feature information; and use the label generation network to generate user labels based on the plurality of pieces of feature information.

In some embodiments, the processor 162 is further configured to perform feature extraction on information of each modality in the multimodal information, obtaining corresponding plurality of pieces of extracted feature information; linearize each of the plurality of pieces of extracted feature information, obtaining corresponding plurality of pieces of linearized feature information; and normalize each of the plurality of pieces of linearized feature information, obtaining corresponding plurality of pieces of feature information.

In some embodiments, the multimodal information includes identification information, and at least one of image information or voice information; the label generation network includes a feature fusion network layer and a label classification network layer; the processor 162 is further configured to use the feature fusion network layer to fuse the feature information corresponding to information other than the identification information among plurality of pieces of feature information to obtain fused feature information; and use the label classification network layer to perform matrix multiplication of the fused feature information with the feature information corresponding to the identification information among plurality of pieces of feature information to obtain user labels.

In some embodiments, the processor 162 is further configured to perform identity recognition on a first object, determine the identification information corresponding to the first object; in response to the presence of voice style prompt information corresponding to the identification information stored in a preset database, retrieve the voice style prompt information corresponding to the identification information from the preset database; and generate a reply voice corresponding to the voice to be replied to based on the voice style prompt information.

In some embodiments, the processor 162 is further configured to: respond to a mismatch between the emotional state represented by the voice to be replied to and the emotional state represented by the generated voice style prompt information; generate voice style prompt information corresponding to a first object based on multimodal information; and generate a reply voice corresponding to the voice to be replied to based on the voice style prompt information; or respond to a match between the emotional state represented by the voice to be replied to and the emotional state represented by the generated voice style prompt information; and generate a reply voice corresponding to the voice to be replied to based on the voice style prompt information.

In some embodiments, the processor 162 is further configured to: obtain sample data; generate style prompt information from the sample data using a style generation model to be trained, obtaining style prompt information corresponding to the sample data; calculate loss information between the style prompt information of the sample data and a preset target style prompt information for the sample data; and adjust the model parameters of the style generation model to be trained based on the loss information, obtaining a preset style generation model.

The present disclosure provides a voice interaction device that, in response to acquiring a voice to be replied to corresponding to a first object, obtains multimodal information corresponding to the first object; generates voice style prompt information corresponding to the first object based on the multimodal information using a preset style generation model; and generates a reply voice corresponding to the voice to be replied to based on the voice style prompt information. The voice interaction device provided in the present disclosure automatically generates voice style prompt information that matches the user's voice interaction style based on multimodal information, simplifying the user's voice interaction process and improving the user's voice interaction experience.

The present disclosure provides a computer-readable storage medium storing one or more computer programs, which can be executed by one or more processors to implement the above-described voice interaction method. The computer-readable storage medium can be volatile memory, such as random-access memory (RAM); or non-volatile memory, such as read-only memory (ROM), flash memory, hard disk drive (HDD), or solid-state drive (SSD); or a device including one or any combination of the above-described memories, such as a mobile phone, computer, tablet device, personal digital assistant, etc.

Those skilled in the art should understand that the embodiments of the present disclosure can be provided as methods, systems, or computer program products. Therefore, the present disclosure can take the form of hardware embodiments, software embodiments, or embodiments combining software and hardware. Furthermore, the present disclosure may take the form of a computer program product implemented on one or more computer-usable storage media (including, but not limited to, disk storage and optical storage) containing computer-usable program code.

The present disclosure is described with reference to flowchart and/or diagrams of methods, devices (systems), and computer program products according to embodiments of the present disclosure. It will be understood that each block of the flowchart and/or diagrams, and combinations of blocks in the flowchart and/or diagrams, can be implemented by computer program instructions. These computer program instructions can be provided to a processor of a general-purpose computer, special-purpose computer, embedded processor, or other programmable data processing apparatus to produce a machine, such that the instructions, which execute via the processor of the computer or other programmable data processing apparatus, create means for implementing the functions specified in one or more flowchart and/or one or more diagrams.

These computer program instructions may also be stored in a computer-readable storage medium capable of directing a computer or other programmable data processing apparatus to function in a particular manner, such that the instructions stored in the computer-readable storage medium produce an article of manufacture including instruction means that implement the functions specified in one or more flowchart and/or one or more diagrams.

These computer program instructions can also be loaded onto a computer or other programmable data processing device to cause a series of operational processes to be performed on the computer or other programmable device to produce a computer-implemented process, thereby providing processes for implementing the functions specified in one or more flowcharts and/or one or more diagrams.

The above description is merely embodiments of the present disclosure, but the scope of the present disclosure is not limited thereto. Any variations or substitutions that can be easily conceived by those skilled in the art within the scope of the technology disclosed in the present disclosure should be included within the scope of the present disclosure. Therefore, the scope of the invention should be determined by the scope of the claims.

What is claimed is:

1. A voice interaction method comprising:
in response to acquiring a target voice corresponding to an object, obtaining multimodal information corresponding to the object;
generating voice style prompt information corresponding to the object based on the multimodal information using a preset style generation model; and
generating a reply voice corresponding to the target voice based on the voice style prompt information.

2. The method according to claim 1, wherein:
the preset style generation model includes a label generation sub-model and a style prompt information generation sub-model; and
generating the voice style prompt information includes:
determining a user label corresponding to the object based on the multimodal information using the label generation sub-model; and
generating the voice style prompt information corresponding to the object based on the user label using the style prompt information generation sub-model.

3. The method according to claim 2, further comprising, after generating the voice style prompt information:
establishing a correspondence between identification information corresponding to the object and the voice style prompt information, the identification information including identity information of the object; and
storing the correspondence in a preset database.

4. The method according to claim 2, wherein:
the label generation sub-model includes a feature extraction network and a label generation network; and
determining the user label includes:
performing feature extraction and modality alignment on information of each modality in the multimodal information to obtain a plurality of pieces of feature information using the feature extraction network to; and
generating the user label based on the plurality of pieces of feature information using the label generation network.

5. The method according to claim 4, wherein performing the feature extraction and the modality alignment on the information of each modality in the multimodal information to obtain the plurality of pieces of feature information includes:
performing feature extraction on the information of each modality in the multimodal information to obtain a plurality of pieces of extracted feature information;
linearizing each of the plurality of pieces of extracted feature information to obtain a plurality of pieces linearized feature information; and
normalizing each of the plurality of pieces of linearized feature information to obtain the plurality of pieces of feature information.

6. The method according to claim 4, wherein:
the multimodal information includes identification information, and at least one of image information or voice information;
the label generation network includes a feature fusion network layer and a label classification network layer; and
generating the user label includes:
fusing, using the feature fusion network layer, feature information corresponding to information other than the identification information among the plurality of pieces of feature information to obtain fused feature information; and
performing, using the label classification network layer, matrix multiplication of the fused feature information with the feature information corresponding to the identification information among the plurality of pieces of feature information to obtain the user label.

7. The method according to claim 1, further comprising:
identifying the object to determine identification information corresponding to the object; and
in response to a preset database storing the voice style prompt information corresponding to the identification information, obtaining the voice style prompt information corresponding to the identification information from the preset database.

8. The method according to claim 7, further comprising, after obtaining the voice style prompt information:
in response to a mismatch between an emotional state represented by the target voice and an emotional state represented by the voice style prompt information, generating the voice style prompt information corresponding to the object based on the multimodal information, and generating the reply voice corresponding to the target voice based on the voice style prompt information; and
in response to a match between the emotional state represented by the target voice and the emotional state represented by the generated voice style prompt information, generating the reply voice corresponding to the target voice based on the voice style prompt information.

9. The method according to claim 1, further comprising:
obtaining sample data;
performing style prompt information generation on the sample data using an initial style generation model to obtain the style prompt information corresponding to the sample data;
calculating loss information between the style prompt information corresponding to the sample data and preset target style prompt information for the sample data; and
based on the loss information, adjusting one or more model parameters of the initial style generation model to obtain the preset style generation model.

10. A voice interaction device comprising:
a sensor configured to obtain multimodal information corresponding to an object in response to acquiring a target voice corresponding to the object; and
a processor configured to:
generate voice style prompt information corresponding to the object based on the multimodal information using a preset style generation model; and
generate a reply voice corresponding to the target voice based on the voice style prompt information.

11. The device according to claim 10, wherein:
the preset style generation model includes a label generation sub-model and a style prompt information generation sub-model; and
the processor is further configured to, when generating the voice style prompt information:
determine a user label corresponding to the object based on the multimodal information using the label generation sub-model; and
generate the voice style prompt information corresponding to the object based on the user label using the style prompt information generation sub-model.

12. The device according to claim 11, wherein the processor is further configured to, after generating the voice style prompt information:
establish a correspondence between identification information corresponding to the object and the voice style prompt information, the identification information including identity information of the object; and
store the correspondence in a preset database.

13. The device according to claim 11, wherein:
the label generation sub-model includes a feature extraction network and a label generation network; and
the processor is further configured to, when determining the user label:
perform feature extraction and modality alignment on information of each modality in the multimodal information to obtain a plurality of pieces of feature information using the feature extraction network to; and
generate the user label based on the plurality of pieces of feature information using the label generation network.

14. The device according to claim 13, wherein the processor is further configured to, when performing the feature extraction and the modality alignment on the information of each modality in the multimodal information to obtain the plurality of pieces of feature information:
perform feature extraction on the information of each modality in the multimodal information to obtain a plurality of pieces of extracted feature information;
linearize each of the plurality of pieces of extracted feature information to obtain a plurality of pieces linearized feature information; and
normalize each of the plurality of pieces of linearized feature information to obtain the plurality of pieces of feature information.

15. The device according to claim 13, wherein:
the multimodal information includes identification information, and at least one of image information or voice information;
the label generation network includes a feature fusion network layer and a label classification network layer; and
the processor is further configured to, when generating the user label:
fuse, using the feature fusion network layer, feature information corresponding to information other than the identification information among the plurality of pieces of feature information to obtain fused feature information; and
perform, using the label classification network layer, matrix multiplication of the fused feature information with the feature information corresponding to the identification information among the plurality of pieces of feature information to obtain the user label.

16. The device according to claim 10, wherein the processor is further configured to:
identify the object to determine identification information corresponding to the object; and
in response to a preset database storing the voice style prompt information corresponding to the identification information, obtain the voice style prompt information corresponding to the identification information from the preset database.

17. The device according to claim 16, wherein the processor is further configured to, after obtaining the voice style prompt information:
in response to a mismatch between an emotional state represented by the target voice and an emotional state represented by the voice style prompt information, generate the voice style prompt information corresponding to the object based on the multimodal information, and generate the reply voice corresponding to the target voice based on the voice style prompt information; and
in response to a match between the emotional state represented by the target voice and the emotional state represented by the generated voice style prompt information, generate the reply voice corresponding to the target voice based on the voice style prompt information.

18. The device according to claim 10, wherein the processor is further configured to:
obtain sample data;
perform style prompt information generation on the sample data using an initial style generation model to obtain the style prompt information corresponding to the sample data;
calculate loss information between the style prompt information corresponding to the sample data and preset target style prompt information for the sample data; and
based on the loss information, adjust one or more model parameters of the initial style generation model to obtain the preset style generation model.

19. A non-transitory computer-readable storage medium storing instructions that, when executed by a processor, cause an electronic device including the processor to:
in response to acquiring a target voice corresponding to an object, obtain multimodal information corresponding to the object;
generate voice style prompt information corresponding to the object based on the multimodal information using a preset style generation model; and
generate a reply voice corresponding to the target voice based on the voice style prompt information.

20. The storage medium according to claim 11, wherein:
the preset style generation model includes a label generation sub-model and a style prompt information generation sub-model; and
the instructions, when executed by the processor, further cause the electronic device to, when generating the voice style prompt information:
determine a user label corresponding to the object based on the multimodal information using the label generation sub-model; and
generate the voice style prompt information corresponding to the object based on the user label using the style prompt information generation sub-model.
